(19) United States
(12) Patent Application Publication
(10) Pub. No.: US 2009/0164679 A1
(43) Pub. Date: Jun. 25, 2009

(54) DATA TRANSMISSION METHOD AND CORRESPONDING DEVICE

(75) Inventors: Aurelien Hars, Meylan (FR); Stephane Masson, Grenoble (FR)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: STMicroelectronics (Grenoble) SAS, Grenoble (FR)

(21) Appl. No.: 12/337,057

(22) Filed: Dec. 17, 2008

(30) Foreign Application Priority Data
Dec. 24, 2007 (FR) 07 60338

(51) Int. Cl. G06F 13/00

(52) U.S. Cl. 710/108

(57) ABSTRACT

A method for transmitting data in packets between a first circuit element and a second circuit element includes sending the data by the first circuit element followed by a reception and a storage of the data by the second circuit element. A data transmission flow control operation detects an event signaling an imminent state of congestion of the data stored by the second circuit element. In response thereto, the control operation stops the sending of the data from the first circuit element to the second circuit element until a delay period expires and the event is no longer detected.

### PRIORITY CLAIM

The present application is a translation of and claims priority from French Application for Patent No. 07 60338 of the same title filed Dec. 24, 2007, the disclosure of which is hereby incorporated by reference.

### BACKGROUND OF THE INVENTION

1. Technical Field of the Invention

The present invention relates to the transmission of binary information words between two components incorporated within one and the same system, for example between two integrated circuits (or chips) implemented on the printed circuit of a portable telephone.

2. Description of Related Art

Data transmission generally comprises a transmitted data flow control. This control is aimed mainly at avoiding data congestion, which not only disrupts the transmission data rate but also provokes a loss of data. There are several techniques for controlling this flow of data. For example, the flow of data can be controlled according to the credit control technique, the threshold control technique or even the resource allocation control technique. Another technique, based on the allocation of a right of priority to certain packets, is described in the article “Congestion Control for High Speed Packet Switched Networks” by K. Bala, I. Cidon and K. Sohraby, INFOCOM 1990, pages 520-526. In the event of data congestion on the transmission bus, only the data packets classified as priority are transmitted.

### SUMMARY OF THE INVENTION

According to one implementation and embodiment, a device and a method are proposed that make it possible in particular to avoid data congestion situations.

According to a first aspect, there is proposed a method of transmitting data in packets between a first circuit element and a second circuit element, comprising at least a sending of data by the first circuit element followed by a reception and a storage of the data by the second circuit element.

According to a general characteristic of this first aspect, the method also comprises a data transmission flow control comprising: a detection of an event signaling the imminence of a state of congestion of the data stored by the second circuit element, and a stopping of the sending of the data to the second circuit element concerned after detection of said event.

In other words, a data congestion is notified by the detection of an event signaling the imminence of the state of congestion. The detection of this event provokes the stopping of the sending of the data to the second circuit element concerned, before the congestion occurs and no loss of data results. Also, only the transmission between the first circuit element and the second circuit element concerned is stopped. It continues between the other elements of the system. For example, said event can be dependent on the second circuit element.

This first aspect can also comprise, after the stopping of the sending of the data, a verification of the state of the data stored by said second circuit element on expiry of a chosen time period, and a resumption of the sending of the data to the second circuit element if said event is no longer detected or a repetition of the verification step otherwise.

According to one embodiment, simultaneously with the stopping of the sending of the data, a countdown of said chosen time period can be initiated.

As a variant, according to another embodiment, the method can also comprise a check on the reliability of the information conveyed by the transmitted data, which comprises, on the one hand, a sending of an acknowledgement by the second circuit element on request from the first circuit element and, on the other hand, the sending of an error message from the second circuit element to the first circuit element in the event of an error in the received data, the sending of the data to the second circuit element concerned being stopped if a requested acknowledgement is not received by the first circuit element concerned or if an error message is transmitted by the second circuit element concerned.

In this variant, a countdown of said chosen time period is initiated at the start of the data transmission, said countdown being repeated each time the chosen time period elapses, and when said time period has elapsed, on completion of said verification of the state of the data stored by said second circuit element, another verification is performed on the reliability of the information conveyed by the transmitted data and the sending of the data is resumed if the acknowledgement has been received or if the error concerning the transmitted data has been corrected, and provided that said event is no longer detected.

According to another aspect, there is proposed a data transmission device incorporated within a system, comprising at least one first circuit element and at least one second circuit element coupled using transmission means, each first circuit element comprising means of sending data in packets, and each second circuit element comprising means of receiving and means of storing the data.

According to a general characteristic of this other aspect, the device comprises means of controlling the transmission flow of the sent data comprising: first means able to detect an event signaling the imminence of a state of congestion of the data stored by the second circuit element, and main control means coupled to the first means and to the transmission means, able to stop the sending of the data after detection of said event. Said event is, for example, the attainment of a fill ratio of the data storage means, said ratio being dependent on the second circuit element concerned.

According to one embodiment, said first means can also be able to verify the state of the data stored by said second circuit element on expiry of a chosen time period, and said main control means can also be capable of enabling, at the end of a chosen time period, the resumption of the sending of the data to the second circuit element concerned, if said event is detected or not.

Said device can also comprise downcounting means able to countdown said chosen time period. Said downcounting means can be able to initiate the countdown simultaneously with the stopping of the sending of the data performed by the main control means.

According to one embodiment, the downcounting means can be able to cyclically countdown said chosen time period, said device then being able to also comprise auxiliary control means able to check the reliability of the information conveyed by the transmitted data, comprising second means incorporated in the second circuit element able to send acknowledgements on request from the first circuit element concerned, and transmission means incorporated in the second circuit element, able to send an error message to the first circuit element concerned in the event of an error in the received data.

Moreover, the main control means are able: to stop the sending of the data between the first circuit element and the second circuit element concerned, if an acknowledgement requested by said first circuit element is not received or if an error message is sent by said second circuit element, to enable, at the end of said chosen time period, a resumption of the sending of the data to the second circuit element concerned, if said first circuit element has received the requested acknowledgement or if the error concerning the transmitted data has been corrected.

A part of the second circuit elements and/or of the first circuit elements can be formed by transmission nodes, coupling the transmission means to each other.

A part of the second circuit elements and/or of the first circuit elements can be formed by electronic chips.

The transmission node can in fact be considered as a first or as a second circuit element. Thus, the data transmission flow control is performed all along the transmission path.

Moreover, the sent packets can include a 16-bit header, the last field of the header indicating whether said packet is valid or not.

According to another aspect, there is proposed a communication system, in particular a portable telephone, incorporating a device such as that described hereinabove.

According to another aspect, there is proposed a data transmission device incorporated within a system (for example located on the printed circuit of a portable telephone), comprising at least one first circuit element and at least one second circuit element coupled using a transmission means, each first circuit element comprising means of sending data in packets, and each second circuit element comprising means of receiving and means of storing the data.

According to a general characteristic of this other aspect, the device can also comprise: auxiliary control means able to check the reliability of the information conveyed by the transmitted data comprising second means, able to send acknowledgements on request from the first circuit element concerned, and sending means, able to send an error message to the first circuit element concerned in the event of an error in the received data, main control means able: to stop the sending of data between the first circuit element and the second circuit element concerned, if an acknowledgement requested by said first circuit element is not received or if an error message is sent by said second circuit element, to enable, at the end of a chosen time period, a resumption of the sending of the data to the second circuit element concerned, if said first circuit element has received the acknowledgement or if the error concerning the transmitted data has been corrected, downcounting means able to countdown said chosen time period, said downcounting means being able to initiate the countdown simultaneously with the stopping of the sending of the data performed by the main control means.

For this aspect as well, the sent packets can include a 16-bit header, the last field of the header indicating whether said packet is valid or not.

According to another aspect, there is proposed another method of transmitting data in packets between a first circuit element and a second circuit element incorporated within one and the same system. This other method comprises at least a sending of data by the first circuit element, followed by a reception and a storage of the data by the second circuit element.

According to a general characteristic of this other aspect, the method also comprises a check on the reliability of the information conveyed by the transmitted data, which comprises, on the one hand, a sending of an acknowledgement by the second circuit element on request from the first circuit element and, on the other hand, the sending of an error message from the second circuit element to the first circuit element in the event of an error in the received data, the sending of the data to the second circuit element concerned being stopped if a requested acknowledgement is not received by the first circuit element concerned or if an error message is sent by the second circuit element concerned.

In this case, a countdown of said chosen time period is initiated at the moment when the sending of the data is stopped. When said time period has elapsed, a verification is performed on the reliability of the information conveyed by the transmitted data. The sending of the data is resumed if the acknowledgement has been received or if the error concerning the transmitted data has been corrected.

### BRIEF DESCRIPTION OF THE DRAWINGS

Other characteristics and advantages of the various aspects will become apparent from studying the detailed description of non-limiting examples, and the following figures:

FIG. 1 illustrates a transmission device according to one embodiment;

FIG. 2 illustrates an implementation of a transmission method;

FIGS. 3 to 8 illustrate various steps of an implementation of the data flow control;

FIG. 9 illustrates an exemplary implementation of the data flow control and of the check on the reliability of the information conveyed by the transmitted data, associated with the counting down of a chosen time period, this countdown being repeated each time the chosen time period elapses;

FIG. 10 illustrates in more detail one embodiment of a second circuit element, in the case where a check on the reliability of the transmitted information is performed;

FIG. 11 illustrates one embodiment of the sending and receiving of acknowledgements in the context of the check on the reliability of the transmitted information;

FIG. 12 very schematically illustrates the check for errors in the received data;

FIG. 13 illustrates an example of data packets transmitted when a data transmission flow control is performed according to an implementation illustrated in FIG. 2; and

FIG. 14 illustrates an example of data packets transmitted when an implementation of the transmission method is, for example, that illustrated in FIG. 9.

### DETAILED DESCRIPTION OF THE DRAWINGS

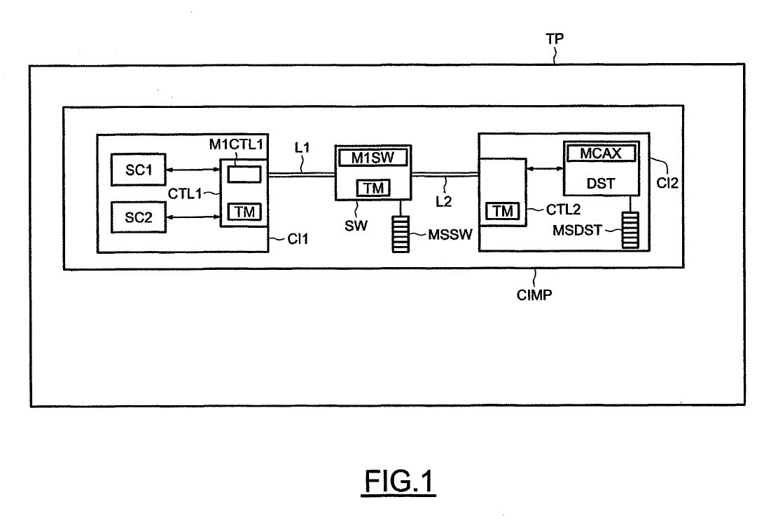

In FIG. 1, the reference TP denotes a communication system, for example a portable telephone. This portable telephone TP comprises a printed circuit CIMP. On this printed circuit CIMP there are, for example, two integrated circuits, respectively referenced CI1 and CI2. Only two integrated circuits are shown in the interests of simplicity, but the printed circuit CIMP can comprise several sending sources and several recipients interlinked via a transmission network.

Hereinafter, the integrated circuit referenced CI1 acts as the information sending circuit (first circuit element), while the integrated circuit CI2 (second circuit element) receives the information sent by the circuit CI1. Obviously, the roles of the two circuits can be swapped. For simplicity, only the constituent elements of the circuits, associated with their sending or receiving function, are represented.

The integrated circuits CI1 and CI2 are here coupled via transmission means L1 and L2. A transmission node SW connects the two links L1 and L2. In this example, the transmission node SW can be considered as an intermediate recipient of the information sent by the circuit CI1 to the circuit CI2. More specifically, in this example, the circuit CI1 comprises two sources SC1 and SC2, each source being, in this example, able to send a given type of information, such as sound information for SC1 and image information for SC2. The sources SC1 and SC2 are coupled to a main control means CTL1 which controls the sending of the information via the transmission means L1 which are, in this case, a data bus.

The main control means CTL1 is capable of controlling both the information sent by the source SC1 and by the source SC2. This main control means CTL1 forms the data sending means of the sources SC1 and SC2.

The main control means CTL1 comprises downcounting means, in this case a clock TM (or “timer”) used to control the transmission of the flow of the data sent by the two sources SC1 and SC2. As a variant, the circuit CI1 could comprise two clocks, one clock for each source SC1 and SC2. Moreover, the main control means CTL1 comprises first means M1CTL1 able to detect an event signaling a state of congestion of the data stored by one of its recipients, in this example the transmission node SW, coupled to the circuit CI1 via the bus L1. This event will be described in more detail hereinbelow.

The circuit CI1 is coupled to the transmission node SW via the bus L1. This transmission node SW therefore acts as a recipient with respect to the circuit CI1.

Like the control means CTL1 of the circuit CI1, the transmission node SW comprises downcounting means TM. The means TM in the node SW are associated with the control of the data transmitted via this transmission node.

In the context of a check on the reliability of the transmitted information, by the sources SC1 and SC2, the control means CTL1 is capable of receiving acknowledgements, and error messages from a recipient. The acknowledgements indicate that the data sent by one of the sources SC1 or SC2 has indeed arrived at its destination. The error messages signal that the data sent by the sources SC1 and SC2 included an error on reception; for example, a data packet has been lost in transmission.

The transmission node SW comprises storage means MSSW able to store each data packet sent by one of the sources SC1 or SC2 before forwarding them to the final recipient. In the context of the data flow control, the transmission node SW comprises first means M1SW able to detect the event signaling the imminence of a state of congestion of the data. These first means M1SW will be described in more detail hereinbelow.

The integrated circuit CI2 in this example comprises a recipient DST; but it should be noted that the integrated circuit CI2 could comprise several recipients. This recipient DST (for example, an electronic chip) comprises means of storing the received data packets MSDST. The recipient DST is coupled to a main control means CTL2 able to control the transmission of data via the bus L2. This main control means CTL2 forms the reception means of the recipient DST.

In the context of a check on the reliability of the transmitted information, the recipient DST can also comprise auxiliary control means MCAX able to send acknowledgements to the source concerned if the latter requests it, or even able to send error messages if the received data is received including an error.

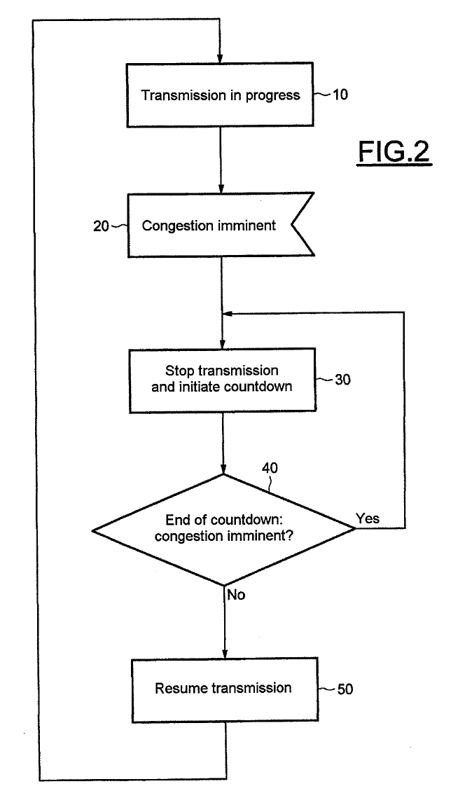

Reference is now made to FIG. 2 which illustrates one implementation of the transmission method according to which the device represented in FIG. 1 can operate, and more particularly an implementation of the data flow control. It is assumed that the transmission of data between a source and a recipient (for example, the source SC1 and the transmission node SW, or even the transmission node SW and the recipient DST) is in progress, step 10. Then, during a step 20, an event signaling the imminence of (or warning of) a data congestion situation is detected. In other words, if the transmission of data between the source and the recipient concerned were to continue, a data congestion state would result. The transmission between the source and the recipient concerned is then stopped. However, the transmission between the source and other recipients, via other buses, can continue. At the moment when the transmission between the two elements concerned is stopped, a countdown of a chosen time period is initiated, step 30. At the end of the countdown, a verification is carried out to see if the event warning of the data congestion is still present. If it is, the countdown is repeated, step 30. Otherwise, the transmission between the two elements concerned resumes, step 50.

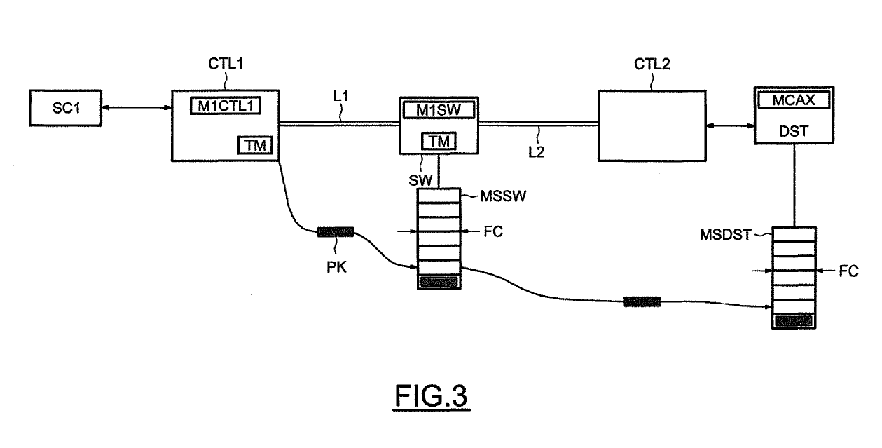

Reference is now made to FIGS. 3 to 8 which illustrate one implementation of a data flow control during a transmission within a device as illustrated in FIG. 1. The device of FIG. 1 is here represented in a very simplified manner.

In the example illustrated in FIG. 3, the source SC1 transmits a packet PK to a final recipient DST via an intermediate recipient, in this case the transmission node SW. As described hereinabove, the transmission between the source SC1 and SW via the bus L1 is controlled by the main control means CTL1.

The packet PK is stored in the storage means MSSW of the transmission node SW. This storage is possible as long as a threshold FC corresponding to a fill ratio of the storage means MSSW is reached. The threshold FC is adapted to the recipient concerned, in this case the transmission node SW. This threshold represents a congestion condition. In other words, as long as the threshold FC is not reached, it is estimated that the transmission of the data between a source and the recipient (in this case the transmission node SW) is carried out normally. If this threshold is reached, it is estimated that a congestion of the data on the recipient concerned is imminent.

It would be possible to define other congestion conditions. For example, the congestion could be defined by an average number of packets received per second. It would also be possible to imagine a hysteresis system in which the congestion condition is triggered by overshooting a first threshold and the congestion situation ends on falling below another threshold, lower than said first threshold. Then, the transmission node SW transmits the packet PK via the bus L2 to the recipient DST. This transmission is controlled by the main control means CTL2. The recipient DST stores the packet PK in its own storage means MSDST. As for the intermediate recipient SW, a threshold FC is associated with the storage means MSDST of the recipient DST. As long as this threshold FC is not reached, it is estimated that the transmission between the communication node SW and the recipient DST is performed normally.

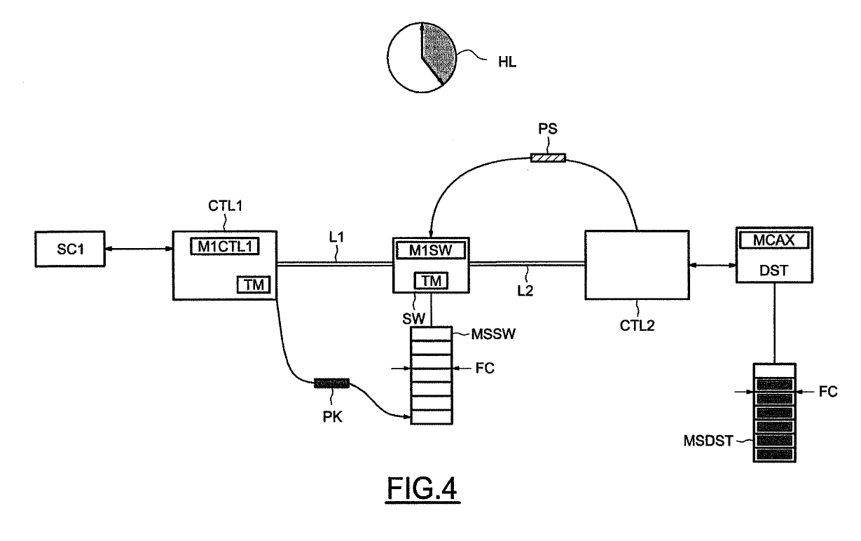

Reference is now made to FIG. 4. In this figure, the threshold FC of the storage means MSDST of the recipient DST has been reached during the data transmission. In this case, the main control means of the bus L2, CTL2, sends a message PS to the first control means M1SW of the transmission node SW. Thus, the transmission node SW detects the imminence of the data congestion within the recipient DST. The transmission of data between the transmission node SW and the recipient DST is stopped. The node SW stops transmitting the data packets to the recipient DST. The packets that the node SW continues to receive from the source SC1 are stored in its storage means MMSW. In practice, the transmission of the data packets between the source SC1 and the transmission node SW continues and is carried out normally.

Since the transmission of data is stopped towards the recipient concerned, before its storage means are entirely filled, the data congestion is avoided, and therefore so too is the loss of data packets.

Simultaneously with the stopping of the transmission of the data packets between the node SW and the recipient DST, the clock TM of the transmission node SW initiates the countdown of a chosen time period. This countdown is symbolized by a dial HL in which the shaded portion corresponds to the time already elapsed, and the white portion to the time remaining to be counted down before the end of the chosen time period. This time period is chosen according to the type of application and the technology used.

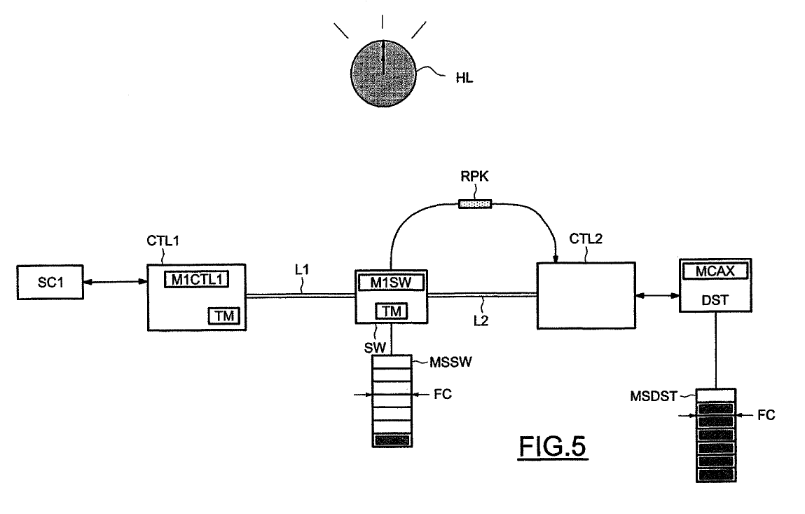

Reference is now made to FIG. 5. As can be seen on the dial HL, when the time period to be counted down has elapsed, the transmission node SW sends a request RPK to the recipient DST. This request RPK enables the transmission node SW to verify whether the fill ratio of the storage means MSDST of the recipient DST is still greater than the threshold FC, which is the case in the example illustrated in FIG. 5.

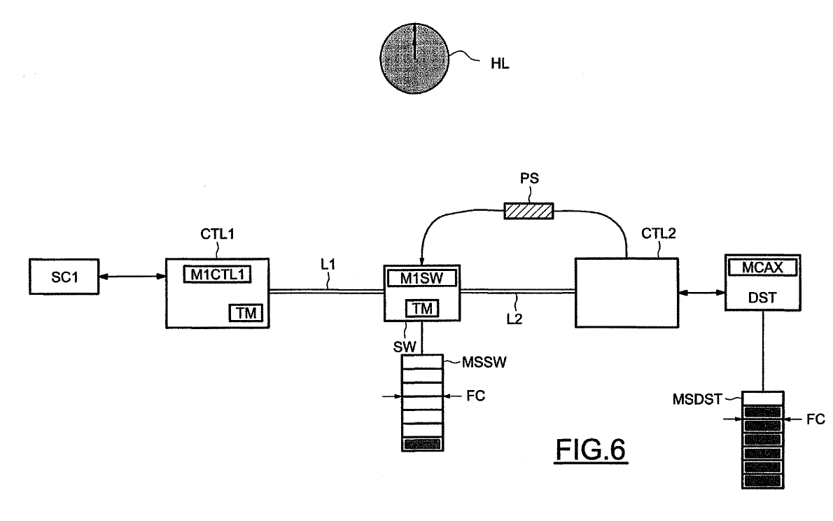

Consequently, as illustrated in FIG. 6, the controller CTL2 forwards a message PS to stop the transmission of the data over the bus L2 between the transmission node SW and the recipient DST.

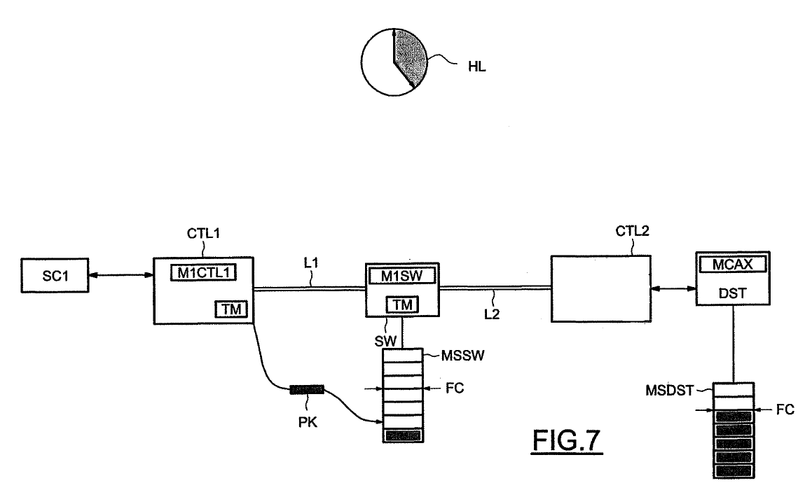

Reference is now made to FIG. 7, the clock TM of the transmission node SW has initiated a new countdown of the chosen time period (see the dial HL symbolizing this countdown). The transmission between the source SC1 and the node SW is, however, still not interrupted. As can be seen in FIG. 7, the fill ratio of the storage means MSDST of the recipient DST has fallen below the threshold FC.

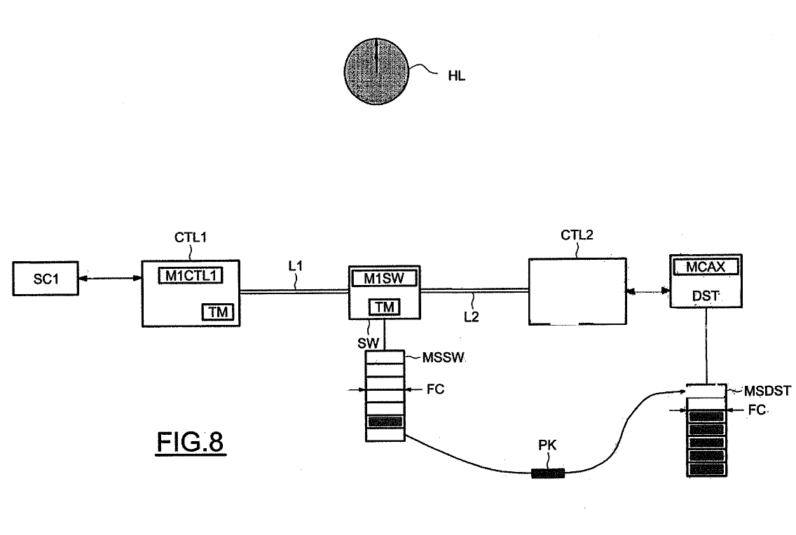

Consequently, as illustrated in FIG. 8, at the end of the countdown of the chosen time period (symbolized by the dial HL), and after a new request from the communication node SW to the recipient DST, the transmission of data between the communication node SW and the recipient DST resumes.

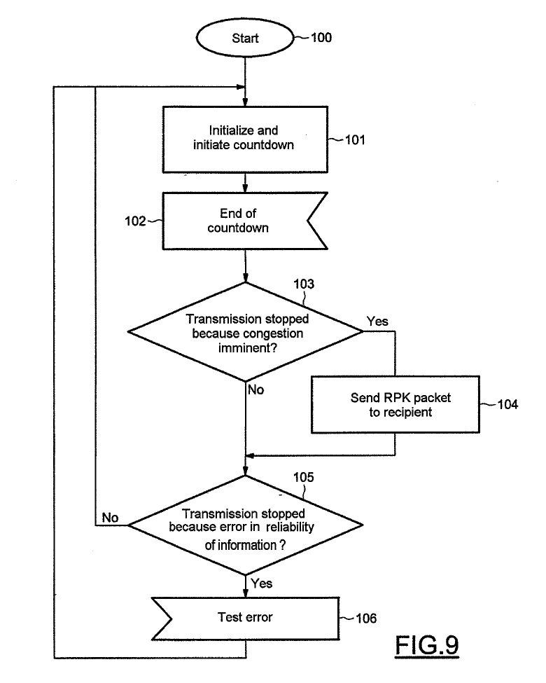

Reference is now made to FIG. 9. This figure illustrates an example of the sequencing of steps when, besides the data flow control, the transmission of the data also comprises the check on the reliability of the information contained by this data. The check on the reliability of the information mainly comprises two steps, namely the sending of an acknowledgement by the recipient to the source when the latter requests it, and the sending of an error message from the recipient to the source when the recipient records an error in the information that it has received.

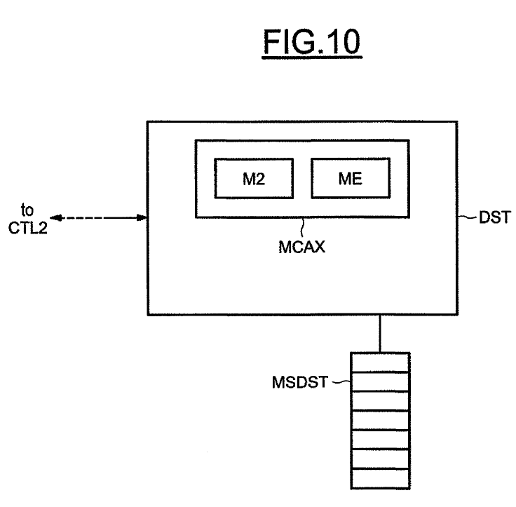

To implement the check on the reliability of the information contained by the data, the auxiliary control means MCAX of the recipient DST comprise second means M2, able to send acknowledgements on request from the source concerned, and sending means ME, able to send an error message to the source concerned in the event of an error in the received data, as illustrated in FIG. 10.

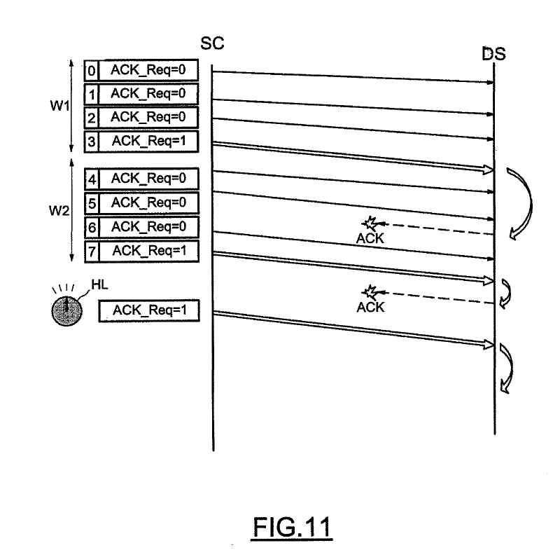

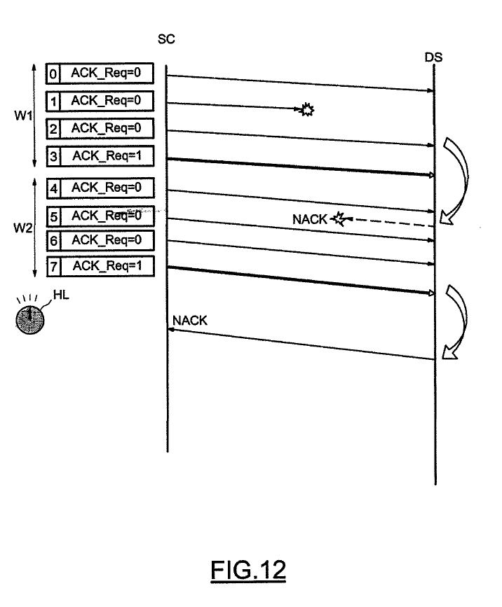

The check on the reliability of the information will be described in more detail hereinbelow through FIGS. 11 and 12.

Reference is once again made to FIG. 9. The steps represented in the flow diagram of this figure first comprise a start of transmission of the data, step 100. After an initialization, a countdown of a chosen time period begins, step 101. The value of this time period is chosen according to the application. The countdown presented here is different from that illustrated in the preceding figures. In practice, in the preceding figures, the countdown was initiated when the transmission of the data was stopped. In this example, the chosen time period is initiated cyclically. In other words, immediately the countdown is terminated, the countdown is resumed automatically from the chosen time period.

When the countdown is terminated, step 102, a verification is carried out to see if the transmission of data has been stopped, because an event signaling the imminence of a congestion has been detected, step 103. If such is the case, the element that is the source of the transmission sends a request to the recipient at the limit of the congestion, so as to know if it is possible to resume the transfer of data, step 104.

At the end of this step 104, or if no event signaling the imminence of a data congestion state has been detected, a verification is carried out during a step 105 to see if the transmission has not been stopped because of an error in the reliability of the information. These errors are specified in more detail hereinbelow.

If no error of this type has been detected, the countdown is resumed from the chosen time period and the steps 101 to 105 are repeated. Otherwise, a verification is carried out during a step 106 to see if the error is corrected or not. If it is, the transmission can resume its normal progress (provided that the event signaling the imminence of a congestion state is not or is no longer detected). Then, the countdown is resumed from the chosen time period and the steps 101 to 106 are repeated.

Reference is now made to FIG. 11, which illustrates the check on the reliability of the information contained in the transmitted data, and more particularly the principle of the sending of acknowledgements from the recipient to a source. This example assumes the case of data sent from a source SC to a recipient DS, using transmission windows making it possible to send four data packets in succession. A first transmission window W1 is used to send the packets numbered from 0 to 3. Each packet contains a field having a variable ACK_Req. This variable is at 0 or at 1 depending on whether an acknowledgement ACK is requested or not of the recipient when it receives this data packet. For example, the packets 0, 1 and 2 do not require the recipient to send an acknowledgement by return. However, the packet numbered 3 asks the recipient to send it an acknowledgement by return (ACK_Req=1).

Similarly, the second transmission window W2 is used to transmit the data packets numbered from 4 to 7. Only the packet numbered 7 asks the recipient to send an acknowledgement ACK by return.

As can be seen, the acknowledgements ACK sent by the recipient DS in response to the packets numbered 3 and 7 sent by the source, do not arrive at the source SC. This is one example of the errors mentioned hereinabove. In this example, the transfer of data between the source SC and the recipient DS is not immediately frozen to take account of a possible delay in the transmission of an acknowledgement ACK. In practice, the source SC has to be able to differentiate an acknowledgement that arrives with a certain delay from an acknowledgement that fails to arrive. The source SC therefore continues to send the packets numbered from 4 to 7, provided that the transmission node has not reached its storage limits. This proviso provides for a possible resending of the unreceived packets (which would not be possible if the storage means of the transmission node were saturated).

When the transmission between the source SC and the recipient DS is frozen, no data packet is transmitted between these two elements. The source SC then sends an acknowledgement request, ACK_Req=1, and waits for the recipient DS to effectively send it an acknowledgement ACK to resume the transmission of data.

If, on expiry of the countdown of the chosen time period (step 102 of FIG. 9) symbolized by the dial HL, the acknowledgement ACK requested by the source has actually been received, then the transmission of data between the source SC and the recipient DS can resume.

Reference is now made to FIG. 12 which illustrates the principle of sending of an error message by a recipient to a source. In this figure, on the transfer of data between the source SC and the recipient DS, a data packet, numbered 1 in this example, is not received by the recipient DS. When the recipient DS receives the packet numbered 2, it notices an interruption in the numbering of the received packets: in practice, it has not received the packet numbered 1. In this case, it sends an error message NACK to the source SC. In this example, this first NACK message is not received by the source SC. Consequently, when the source SC sends a data packet (in this case numbered 7) requesting the recipient DS to send an acknowledgement by return (ACK_Req=1), the recipient DS sends a new NACK message.

The sending of this NACK message is another example of the errors mentioned hereinabove. In this case, the current transmission of data is stopped and resumes only when the packets numbered 1 to 7 have been returned in this order to the recipient. When the chosen time period (symbolized by the dial HL) has elapsed (step 102 in the flow diagram of FIG. 9), if the data packets numbered 1 to 7 have actually been resent by the source to the recipient DS, the transmission of data between the source SC and the recipient DS can resume its normal progress.

As a variant, it is possible to have other downcounting means, separate from those used for a control of the data flow and specifically adapted to checking the reliability of the information. In this case, the countdown can be initiated at the moment when the data transfer is frozen.

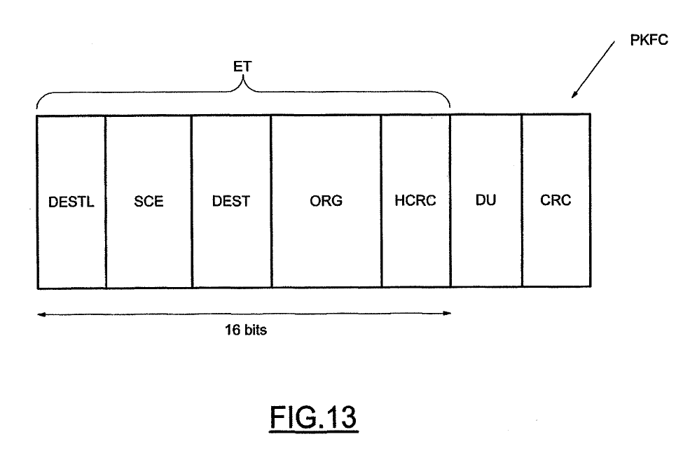

FIG. 13 illustrates an example of a data packet that is particularly suited to the transfer of data when the flow control is performed according to the example described hereinabove. However, the transmission of data can also be performed with a data packet having a standard structure (for example, the frames used for the LAP-B protocol, described in the manual by Guy Pujolle entitled “les Réseaux” (Networks), in chapter 5 of the second edition (ISBN 2-212-08967-8)).

In this example, a data packet referenced PKFC comprises a header encoded on 16 bits (the header can be encoded on a larger number of bits, if there is a large number of circuits connected by the network). This header ET comprises a field DESTL with the address of the local recipient (for example, the recipient DST in FIG. 1), a field SC indicating the sending source (for example, one of the sources SC1 or SC2 represented in FIG. 1), a field DEST indicating the recipient of the transmitted data packet (for example, the circuit CI2 in FIG. 1), a field ORG indicating which is the sender of the data (for example, the sending circuit CI1 in FIG. 1), and a field HCRC indicating, on the one hand, the end of the header ET and, on the other hand, that the header has been correctly received, that is, without the transmission channel having introduced errors. This header in this example comprises 16 bits.

Finally, the packet PKFC comprises a payload data field DU and a field CRC indicating, on the one hand, the end of the packet and, on the other hand, that the data has been correctly received, that is, without the transmission channel having introduced errors. In this example, the field CRC comprises a cyclic redundancy code.

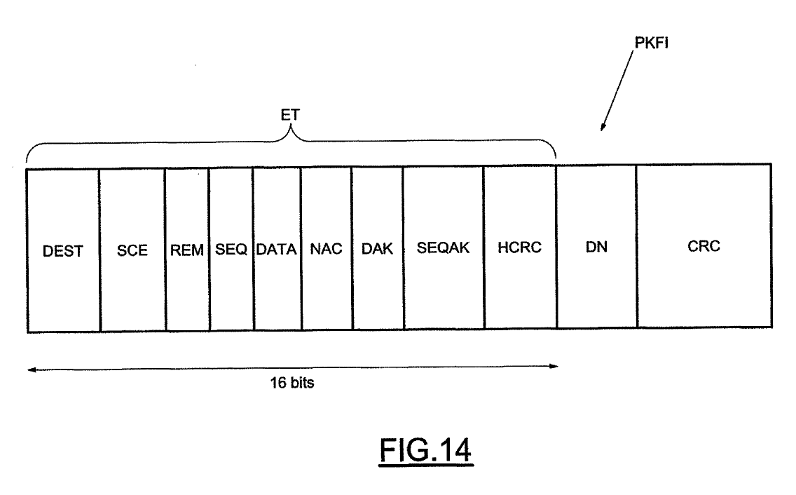

FIG. 14 illustrates an example of a data packet referenced PKFI that is particularly suitable for a transmission of data when it comprises a control of the data flow and a check on the reliability of the information contained in the transmitted data. The packet PKFI comprises a header ET containing the abovementioned fields DEST and SCE. The header ET also comprises a field REM which indicates whether the packet is currently being resent or not, a field SEQ indicating the sequence number (this field tells the recipient whether a data packet has been lost, if it receives, for example, a packet numbered N−1 followed by a packet numbered N+1; in this case, the recipient knows that the packet numbered N has been lost); a field referenced DATA which comprises data intended for a possible transmission node positioned on the transmission network; a field referenced NAC which signals when the recipient requests the retransmission of packets from a certain sequence number stored in a field SEQAK (in this case, NAC=1); moreover, the field NAC indicates that all the packets sent as far as the packet whose sequence number is stored in SEQAK have been correctly received; when NAC=0, the packet concerned indicates only that all the packets sent as far as the packet whose sequence number is stored in SEQAK have been correctly received. The header ET also comprises a field referenced DAK which indicates that the source is asking for an acknowledgement from the recipient of the data packet, the abovementioned field SEQAK and a field HCRC which indicates, on the one hand, the end of the header ET and, on the other hand, that the header has been correctly received, that is, without the transmission channel having introduced errors.

The header is in this case encoded on 16 bits. The field PKFI also comprises a field referenced DN which comprises the data intended for the sender if the latter can also act as recipient, and a field CRC indicating, on the one hand, the end of the packet and, on the other hand, that the data has been correctly received, that is, without the transmission channel having introduced errors.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method of transmitting data in packets between a first circuit element and a second circuit element, comprising:
sending of data by the first circuit element;
receiving and storing of the data by the second circuit element; and
performing data transmission flow control comprising:
detecting an event which signals an imminent state of congestion with respect to the storage of data by the second circuit element; and
stopping the sending of the data to the second circuit element after detection of said event.

2. The method according to claim 1, wherein said event which is detected is an event dependent on operation of the second circuit element.

3. The method according to claim 1, further comprising, after stopping the sending of the data:
verifying a state of the data stored by said second circuit element on expiry of a time period, and
resuming the sending of the data to the second circuit element if said event is no longer detected after time period expiration.

4. The method according to claim 3, wherein verifying comprises initiating a counting of the time period simultaneously with the stopping of the sending of the data.

5. The method according to claim 1, further comprising checking on a reliability of the information conveyed by the transmitted data, wherein checking comprises sending of an acknowledgement by the second circuit element on request from the first circuit element, the sending of the data to the second circuit element concerned being stopped if a requested acknowledgement is not received by the first circuit element.

6. The method according to claim 1, further comprising checking on a reliability of the information conveyed by the transmitted data, wherein checking comprises sending of an error message from the second circuit element to the first circuit element in the event of an error in the received data, the sending of the data to the second circuit element concerned being stopped if an error message is transmitted by the second circuit element.

7. The method according to claim 1, wherein stopping comprises stopping until expiry of a time period, and further comprising resuming the sending of the data to the second circuit element if said event is no longer detected after time period expiration.

8. The method according to claim 1, further comprising initiating counting of a time period at the start of the data transmission, said counting being repeated each time the time period elapses, and when said time period has elapsed, on completion of a verification of the state of the data stored by said second circuit element, performing another verification on a reliability of information conveyed by the transmitted data, wherein sending of the data is resumed if an acknowledgement is been received or an error concerning the transmitted data has been corrected, and provided that said event is no longer detected.

9. A system, comprising:
a first circuit element;
a second circuit element;
transmission means coupling the first and second circuit elements;
wherein the first circuit element comprises means for sending data in packets, and wherein the second circuit element comprises means for receiving the packets and means for storing the data;
means for controlling the transmission flow of the sent data comprising:
means for detecting an event signaling an imminent state of congestion of the data stored by the second circuit element; and
main control means coupled to the first means for detecting and to the transmission means for stopping the first circuit element from sending the data after detection of said event.

10. The system according to claim 9, wherein said event is the attainment of a fill ratio with respect to data stored in the means for storing at the second circuit element.

11. The system according to claim 9, wherein said means for detecting further verify a state of the data stored by said second circuit element on expiry of a time period, and wherein said main control means further enable, at the end of the time period, the resumption of the sending of the data to the second circuit element.

12. The system according to claim 11, further comprising counting means for counting the time period, the counting means initiating counting simultaneously with the stopping of the sending of the data performed by the main control means.

13. The system according to claim 11, wherein the counting means cyclically counts said time period, and further comprising auxiliary control means for checking a reliability of the information conveyed by the transmitted data, and comprising means incorporated in the second circuit element for sending acknowledgements on request from the first circuit element concerned, and transmission means incorporated in the second circuit element for sending an error message to the first circuit element concerned in the event of an error in the received data, wherein the main control means stops the sending of the data between the first circuit element and the second circuit element concerned, if an acknowledgement requested by said first circuit element is not received or if an error message is sent by said second circuit element, to enable, at the end of said chosen time period, a resumption of the sending of the data to the second circuit element concerned, if said first circuit element has received the requested acknowledgement or if the error concerning the transmitted data has been corrected.

14. The system according to claim 9, wherein a part of either the first or second circuit element is formed by a transmission node coupling the transmission means to the receiving means.

15. The system according to claim 9, wherein a part of either the first or second circuit element is formed by electronic integrate circuit chips.

16. The system according to claim 9, wherein the sent packets include a 16-bit header, a last field of the header indicating whether said packet is valid.

17. The system according to claim 9 as incorporated into a portable telephone (TP).

18. A method for data communication, comprising:
sending data by packet transmission from a source circuit;
receiving the packet transmission at an intermediary circuit;
storing the data in a first memory at the intermediary circuit;
sending the data from the first memory by packet transmission from the intermediary circuit;
receiving the packet transmission at a destination circuit;
storing the data in a second memory at the destination circuit;
performing data transmission flow control comprising:
detecting an event which signals an imminent state of congestion with respect to the storage of data by the intermediary circuit in the first memory; and
stopping the sending of the data from the source circuit to the intermediary circuit after detection of said event while continuing to allow sending of the data from the intermediary circuit to the destination circuit.

19. The method according to claim 18, further comprising, after stopping the sending of the data:
measuring a delay time period, and
resuming the sending of the data from the source circuit to the intermediary circuit if said event is no longer detected after the measured delay time period expires.

20. A method for data communication, comprising:
sending data by packet transmission from a source circuit;
receiving the packet transmission at an intermediary circuit;
storing the data in a first memory at the intermediary circuit;
sending the data from the first memory by packet transmission from the intermediary circuit;
receiving the packet transmission at a destination circuit;
storing the data in a second memory at the destination circuit;
performing data transmission flow control comprising:
detecting an event which signals an imminent state of congestion with respect to the storage of data by the destination circuit in the second memory; and
stopping the sending of the data from the intermediary circuit to the destination circuit after detection of said event while continuing to allow sending of the data from the source circuit to the intermediary circuit.

21. The method according to claim 20, further comprising, after stopping the sending of the data:
measuring a delay time period, and
resuming the sending of the data from the intermediary circuit to the destination circuit if said event is no longer detected after the measured delay time period expires.
